(19) United States
(12) Patent Application Publication
(10) Pub. No.: US 2005/0207815 A1
(43) Pub. Date: Sep. 22, 2005

(54) Manufacturing method of yoke, yoke, wire dot printer head and wire dot printer

(75) Inventors: Yasunobu Terao, Tagata-gun (JP); Takahiro Kawaguchi, Mishima-shi (JP); Keishi Tsuchiya, Tagata-gun (JP)

Correspondence Address: FRISHAUF, HOLTZ, GOODMAN & CHICK, PC, 220 5TH AVE FL 16, NEW YORK, NY, 10001-7708, US

(73) Assignee: Toshiba Tec Kabushiki Kaisha, Tokyo (JP)

(21) Appl. No.: 11/073,092

(22) Filed: Mar. 3, 2005

(30) Foreign Application Priority Data
Mar. 22, 2004 (JP) 2004-082319

(51) Int. Cl. B41J 2/27

(52) U.S. Cl. 400/124.23; 400/124.14

(57) ABSTRACT

In order to restrain the deterioration in assembling precision and prevent the formation of rust and deterioration in magnetic characteristics in a yoke to thereby obtain magnetic characteristics required for high-speed printing, a yoke having a core around which a coil is wound and a reference surface for assembly is made of permendur material, wherein the reference surface is polished so as to be flattened to complete the yoke. Accordingly, the reference surface of the yoke is precisely formed to be flat, thereby being capable of restraining the deterioration in assembling precision. The yoke is made of permendur material, so that the formation of rust on the yoke can be prevented. A plating layer that is a cause of magnetic resistance is not formed on the yoke, whereby the deterioration in magnetic characteristics at the yoke is prevented to thereby be capable of obtaining magnetic characteristics required for high-speed printing.

### CROSS REFERENCE TO RELATED APPLICATION

The present application is based on Japanese Priority Document P2004-082319 filed on Mar. 22, 2004, the content of which is incorporated herein by reference.

### BACKGROUND OF THE INVENTION

1. Field of the Invention

The present invention relates to a manufacturing method of a yoke, a yoke manufactured by the manufacturing method, wire dot printer head using the yoke and a wire dot printer using the same.

2. Discussion of the Background

There has been known a wire dot printer head wherein an armature with a printing wire coupled thereto is pivoted between a printing position and a stand-by position, and when the armature is pivoted to the printing position, a tip of the wire is brought into collision with a printing medium to effect printing. In a certain wire dot printer head of this type, there has been proposed a device wherein a magnetic flux is produced by a coil around the armature, that is to be pivoted, for forming a magnetic circuit that causes the armature to be attracted from a stand-by position to a printing position to effect printing (see JPA Hei-3(1991)-191036).

JPA Hei-3(1991)-191036 discloses a technique wherein a yoke for forming a magnetic circuit is formed by a sintering process by using Fe powders and Co-based powders having fine particle diameter as a material. Further, the yoke made of a SiFe-based magnetic material is generally formed by a sintering process, Lost Wax method and MIM (Metal Injection Molding) method. In this case, an anticorrosion process is required in view of the characteristics of the magnetic material. Examples of the anticorrosion process include a plating or the like.

During the manufacturing process of a yoke, the yoke is firstly formed of a SiFe-based magnetic material by a Lost Wax method (Step S101), and then, the reference surface (reference surface for assembly) is polished so as to be flattened (Step S102) as shown in FIG. 5. Subsequently, an electroless Ni—P plating is performed to the polished yoke (Step S103), and then, the electroless Ni—P plating formed on the surface of the yoke is baked (Step S104). Thereafter, the baked yoke and the other components of a wire dot printer head are assembled with the reference surface of the yoke defined as a reference (Step S105), whereby the wire dot printer head is completed.

However, a plating layer such as the electroless Ni—P plating formed on the surface of the yoke by the plating has weak magnetism that causes a magnetic resistance. Even if the electroless Ni—P plating is transformed into a ferromagnetic material by the baking process like the conventional manufacturing process, the plating layer also becomes a cause of the magnetic resistance. Therefore, magnetic characteristic required for high-speed printing cannot be obtained. As a result, it is impossible to execute high-speed printing. In particular, the armature is required to be pivoted as many as 2500 times per second between the printing position and the stand-by position with a recent increased printing speed, so that the deterioration in the magnetic characteristic becomes an important problem.

Further, the above-mentioned assembling process demands high assembling precision. Accordingly, in case where the plating is performed after polishing the yoke as in the conventional manufacturing process, concaves and convexes, although they are microscopic, are produced on the reference surface due to the plating layer, so that the reference surface of the yoke is not flattened. This deteriorates the assembling precision. On the other hand, in case where the plating is performed before polishing the yoke and after that, the yoke is polished, the plating layer becomes thin or is removed, thereby deteriorating the anticorrosion effect by the plating layer. The conventional manufacturing process requires the plating or baking, resulting in increasing the manufacturing time and further reducing productivity.

### SUMMARY OF THE INVENTION

An object of the present invention is to prevent the deterioration in assembling precision to prevent the formation of rust and deterioration in magnetic characteristics, thereby obtaining magnetic characteristic required for high-speed printing.

A manufacturing method of a yoke according to the present invention includes a step of forming a yoke with permendur material, the yoke having a core around which a coil is wound and a reference surface for assembly, and a step of polishing the reference surface so as to be flattened.

A yoke according to the present invention has a core around which a coil is wound and a reference surface for assembly which is polished to be flattened, wherein the core is made of permendur material.

A wire dot printer head according to the present invention includes: a yoke having a core around which a coil is wound and a reference surface for assembly that is polished so as to be flattened; and an armature positioned opposite to the core, pivotably provided at the yoke and supports a printing wire in a direction generally parallel to its pivotal direction, wherein the core is made of permendur material.

A wire dot printer according to the present invention includes: the wire dot printer head; a platen opposite to the wire dot printer head; a carriage that holds the wire dot printer head and reciprocates along the platen; and a printing medium transporting section that transports a printing medium between the wire dot printer head and the platen, wherein the core is made of permendur material.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a front view in central vertical section schematically showing a wire dot printer head according to one embodiment of the present invention;

FIG. 2 is an exploded perspective view schematically showing a part of the wire dot printer head according to one embodiment of the present invention;

FIG. 3 is an explanatory view showing a flow of a manufacturing process of a yoke according to one embodiment of the present invention;

FIG. 4 is a longitudinal side view schematically showing a wire dot printer according to one embodiment of the present invention; and

FIG. 5 is an explanatory view showing a flow of a conventional manufacturing process of a yoke.

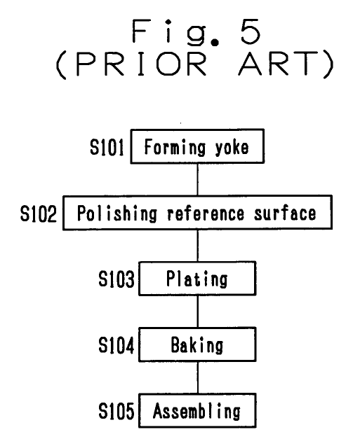

### DETAILED DESCRIPTION OF THE PREFERRED EMBODIMENTS

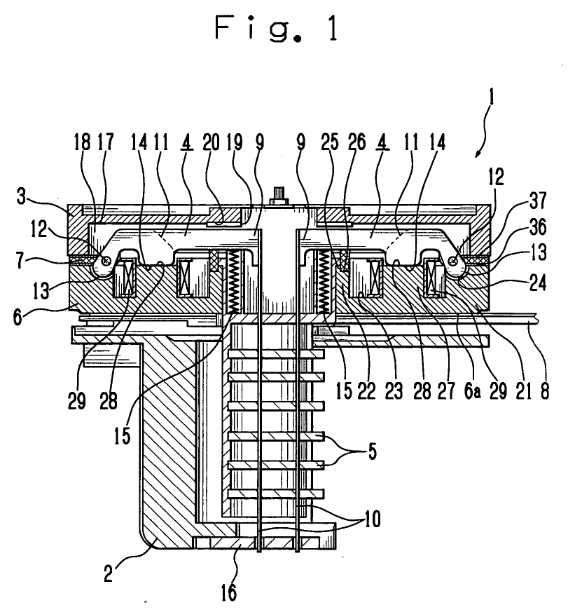

Preferred embodiments for carrying out the present invention will be explained with reference to FIGS. 1 to 4.

[Wire Dot Printer Head]

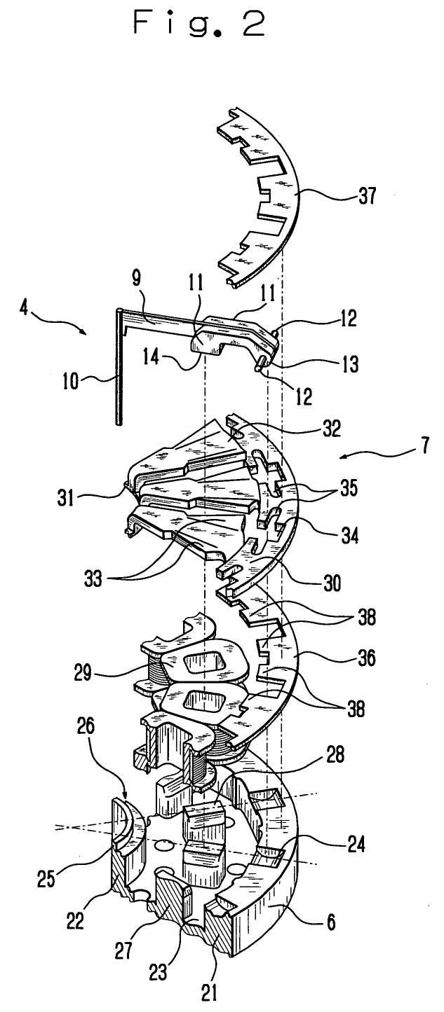

Firstly, the entire construction of a wire dot printer head 1 will be explained with reference to FIG. 1 and FIG. 2. FIG. 1 is a front view in central vertical section schematically showing a wire dot printer head 1 according to the embodiment and FIG. 2 is an exploded perspective view schematically showing a part of the wire dot printer head 1.

The wire dot printer head 1 has a front case 2 and a rear case 3 coupled together with a mounting screw (not shown). Disposed between the front case 2 and the rear case 3 are armatures 4, wire guides 5, yoke 6, armature spacer 7 and circuit board 8.

Each of the armatures 4 has an arm 9 that is formed into a plate-like shape and supports a printing wire (hereinafter simply referred to as a wire) 10 at one end thereof in the lengthwise direction (in the direction in which the arm 9 extends), magnetic circuit forming members 11 formed at both side faces of the arm 9 in the widthwise direction for forming a magnetic circuit, and a pivot shaft 12 that is rendered to be a center of the pivot. The wire 10 is soldered to one end of the arm 9. An arc-shaped section 13 is formed at the other end of the armature 4. An attracted face 14 is formed at each of the magnetic circuit forming members 11. This attracted face 14 is positioned at the central section of the armature 4 in the lengthwise direction.

Plural armatures 4 described above are radially arranged with respect to the center of the yoke 6. Each of the armatures 4 is held at the surface of the yoke 6 such that it is pivotable in the direction away from the yoke 6 with the pivot shaft 12 as a center, and it is urged by an urging member 15 such as a coil spring toward the direction away from the yoke 6. The urging member 15 is provided for executing the urging operation.

Each of the wire guides 5 slidably guides the wire 10 for causing the tip of the wire 10 to strike against the predetermined position of a printing medium. Further, provided at the front case 2 is a tip guide 16 that aligns the tip of the wire 10 in a predetermined pattern and slidably guides the wire 10. It should be noted that the wire 10 moves to a position where the tip thereof strikes against the predetermined position, e.g., the printing medium such as a sheet or the like, with the pivotal movement of the armature 4, when the armature 4 pivots to the printing position.

A cylindrical section 18 having a bottom face section 17 at the side of one end is provided at the rear case 3. A mounting recess section 20 to which a metallic annular armature stopper 19 is attached is formed at the central portion of the bottom face section 17. The mounting of the armature stopper 19 is performed by fitting the armature stopper 19 into the mounting recess 20. When the armature 4 pivots from the printing position by the urging member 15, the arm 9 as part of the armature 4 comes into contact with the armature stopper 19, thereby stopping the pivotal movement of the armature 4. Therefore, the armature stopper 19 has a function for defining the stand-by position of the armature 4.

The circuit board 8 has a driving circuit for controlling the pivotal movement of the armature 4 between the printing position and the stand-by position. The driving circuit of the circuit board 8 selectively pivots an optional armature 4 among plural armatures 4 during the printing operation.

The yoke 6 has a pair of cylindrical sections 21 and 22 that are concentrically mounted, each having a different diameter. The size in the shaft direction (in the vertical direction in FIG. 1, i.e., in the shaft direction of the yoke 6) of each cylindrical section 21 and 22 is set equal to each other. The cylindrical section 21 at the outer periphery side and the cylindrical section 22 at the inner periphery side are formed integral by a bottom face 23 formed so as to close one end in the shaft direction. It should be noted that the yoke 6 is formed by, for example, a Lost Wax method or the like by using PMD (permendur) material that is excellent in magnetic characteristic. The yoke 6 described above is held between the front case 2 and the rear case 3 in a state in which its open side opposite to the bottom face 23 is opposed to an open side of the rear case 3.

Formed at the outer periphery-side cylindrical section 21 are plural recesses 24 that are equal in number of the armatures 4. Each of the recesses 24 has the inner peripheral face formed into a concave shape having a curvature radius approximately same as that of the outer peripheral face of the arc-shaped section 13 of the armature 4. The arc-shaped section 13 formed at one end of the armature 4 is slidably fitted into the recess 24.

A fitted section 25 having an annular shape is provided at the inner periphery-side cylindrical section 22. The fitted section 25 is integrally provided to the inner periphery-side cylindrical section 22 so as to be positioned concentric with the inner periphery-side cylindrical section 22. The outer diameter of the fitted section 25 is set smaller than the outer diameter of the inner periphery-side cylindrical section 22. Accordingly, a step section 26 is formed at the inner periphery-side cylindrical section 22 by the fitted section 25.

Provided integral with the bottom face 23 are plural cores 27 annually arranged between the outer periphery-side cylindrical section 21 and the inner periphery-side cylindrical section 22. The size of each core 27 in the shaft direction of the yoke 6 is set equal to the size of each cylindrical section 21 and 22 in the shaft direction of the yoke 6.

A pole face 28 is formed at one end of each core 27 in the shaft direction of the yoke 6. The pole face 28 of the core 27 is formed so as to oppose to the attracted face 14 of the magnetic circuit forming member 11 provided at the armature 4. Moreover, a coil 29 is wound around the outer periphery of each core 27. Specifically, the yoke 6 has plural cores 27 annually arranged, each core having the coil 29 wound therearound. Although the winding directions of all coils are set equal to one another in this embodiment, the invention is not limited thereto. For example, coils having different winding directions may be selectively arranged.

The armature spacer 7 has a pair of ring-shaped members 30 and 31 having diameters approximately equal to the diameters of the cylindrical sections 21 and 22 of the yoke 6 and plural guide members 32 radially bridged between the ring-shaped members 30 and 31 so as to be positioned between the armatures 4. These guide members 32 form a side magnetic path with respect to the armature 4. The outer periphery-side ring-shaped member 30 and the inner periphery-side ring-shaped member 31 are concentrically provided. The outer periphery-side ring-shaped member 30, the inner periphery-side ring-shaped member 31 and the guide member 32 are integrally formed. The armature spacer 7 described above is formed, for example, by using PMD (permendur) material that is excellent in magnetic characteristic.

When the armature spacer 7 is disposed on the yoke 6, the outer periphery-side ring-shaped member 30 and the inner periphery-side ring-shaped member 31 respectively come in contact with the cylindrical sections 21 and 22 of the yoke 6, whereby the inner periphery-side ring-shaped member 31 is fitted to the fitted section 25. It should be noted that the inner diameter of the inner periphery-side ring-shaped member 31 is set equal to or slightly greater than the outer diameter of the fitted section 25.

Each guide member 32 has a side yoke section 33 extending substantially radially of the ring-shaped members 30 and 31 toward the direction away from the pole face 28 of the core 27 and in the oblique direction. This side yoke section 33 has a blade-like shape that is wider toward the outer periphery-side ring-shaped member 30 from the inner periphery-side ring-shaped member 31.

Since the armature spacer 7 has plural guide members 32 bridged between a pair of ring-shaped members 30 and 31, slit-like guide grooves 34 are ensured that are open along the radius direction of the ring-shaped members 30 and 31. Each guide groove 34 is formed to have such a width that the side yoke section 33 comes close to the associated magnetic circuit forming member 11 to such an extent that it does not obstruct the pivot movement of the armature 4.

Further, the guide groove 34 communicates with the outer periphery-side ring-shaped member 30. Formed at the guide groove 34 at the outer periphery-side ring-shaped member 30 is a bearing groove 35 that is a cut-out section open contiguously to the guide groove 34 at the position of both side faces of the guide groove 34 along the outer diameter direction of the ring-shaped member 30. The pivot shaft 12 of the armature 4 is fitted into this bearing groove 35. Specifically, the pivot shaft 12 of the armature 4 is held by the yoke 6 and the armature spacer 7 such that the armature 4 opposes to the core 27.

Provided between the yoke 6 and the armature spacer 7 is a pin support plate 36 that prevents the contact between the pivot shaft 12 of each of the plural armatures 4 and the yoke 6. A pressing member 37 for pressing the pivot shaft 12 of each of the plural armatures 4 is mounted on the armature spacer 7.

The pin support plate 36 is annually formed so as not to obstruct the pivot of the plural armatures 4 and has plural contact preventing sections 38. The plural contact preventing sections 38 are mounted between the yoke 6 and the plural armatures 4 respectively. Further, the pin support plate 36 is formed into a plate-like shape having a thickness of about 0.20 mm and mounted on the yoke 6 in order to form a magnetic path between the core 27 of the yoke 6 and the armatures 4 with the shortest distance. A hardening process is provided on the surface of the pin support plate 36. A nitriding is used, for example, as the hardening process.

The pressing member 37 is a plate-like member for pressing the pivot shaft 12 of each of the plural armatures 4 by coupling the front case 2 and the rear case 3 with a mounting screw. This pressing member 37 is annually formed so as not to hinder the pivotal movement of the armature 4. The pressing member 37 has plural groove sections 39 having a width approximately same as the width of the armature 4 and respectively extending toward its radius direction. A surface hardening process is provided on the surface of the pressing member 37. A nitriding is used as the surface hardening process, for example.

The diameter of the pivot shaft 12 of the armature 4 is about 0.90 mm and the thickness of the armature spacer 7 composing the bearing groove 35 is about 0.80 mm. Therefore, when the pivot shaft 12 of the armature 4 is fitted into the bearing groove 35, the pivot shaft 12 protrudes from the bearing groove 35 by about 0.10 mm to be in contact with the pressing member 37, thereby providing a secure support.

[Manufacturing Method of Yoke]

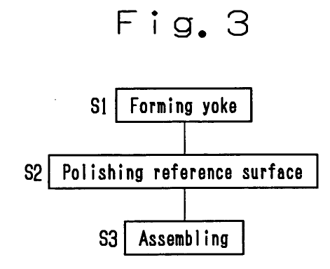

Subsequently, a manufacturing method of the yoke 6 will be explained with reference to FIG. 3. FIG. 3 is an explanatory view showing a flow of a manufacturing process of the yoke 6.

During the manufacturing process of the yoke, the yoke 6 is firstly formed of permendur material by a Lost Wax method (Step S1: forming process), and then, the reference surface 6a of the yoke 6 (see FIG. 1) is polished so as to be flattened (Step S2: polishing process) as shown in FIG. 3. The reference surface 6a of the yoke 6 is polished to ensure the flatness and surface roughness of a predetermined value. By these processes, the yoke 6 is completed. Thereafter, the polished yoke 6 and the other components of the wire dot printer head 1 are assembled with the reference surface 6a of the yoke 6 defined as a reference (Step S3: assembling process), whereby the wire dot printer head 1 is completed.

It should be noted that the reference surface 6a of the yoke 6 is for its assembly, so that it is the lower face of the yoke 6 in the axial direction (in the vertical direction in FIG. 1). This lower face serves as the reference surface 6a upon assembling the wire dot printer head 1. Further, the upper face of the yoke 6 is also polished so as to be flattened during the process for polishing the reference surface 6a of the yoke 6.

The permendur material used for forming the yoke 6 includes plenty of cobalt in its composition. Therefore, the yoke 6 has a sufficient anticorrosion effect only by lubrication to such a degree that grease is applied on the surface thereof.

[Wire Dot Printer]

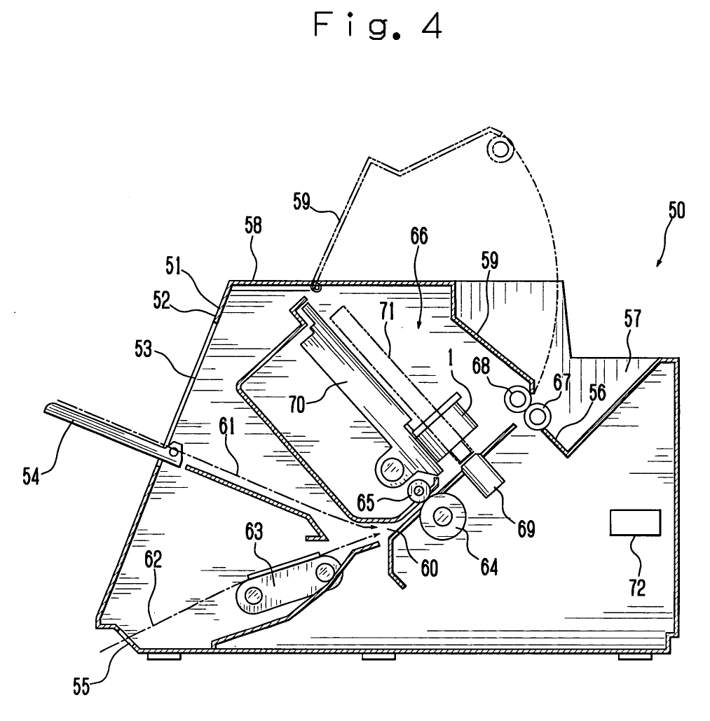

Subsequently explained with reference to FIG. 4 is a wire dot printer 50 provided with the wire dot printer head 1 described above. FIG. 4 is a longitudinal side view schematically showing the wire dot printer 50 according to the embodiment of the present invention.

The wire dot printer 50 has a housing case 51. An opening section 53 is formed at the front face 52 of the housing case 51. A manual tray 54 is mounted at the opening section 53 so as to be able to be opened and closed. Further, a paper feed port 55 is provided at the lower section of the front face 52 of the housing case 51, while a discharge tray 57 is provided at the back face side 56. Moreover, an open/close cover 59 is pivotably provided at the top face 58 of the housing case 51. The opened open/close cover 59 is shown by a virtual line in FIG. 4.

A sheet transporting path 60 that is a printing medium transporting path is provided in the housing case 51. The upstream side in the sheet transporting direction of the sheet transporting path 60 communicates with a paper feed path 61 arranged on the extended face of the opened manual tray 54 and a paper feed path 62 communicating with the paper feed port 55. The downstream side in the sheet transporting direction of the sheet transporting path 60 communicates with the discharge tray 57. A tractor 63 for transporting a sheet is provided in the paper feed path 62.

In the sheet transporting path 60, a transporting roller 64 and a pressing roller 65 are arranged so as to be opposite to each other, wherein the pressing roller 65 comes in pressed contact with the transporting roller 64. These transporting roller 64 and the pressing roller 65 transport a sheet that is a printing medium and compose a sheet transporting section that is a printing medium transporting section. Further, disposed in the sheet transporting path 60 is a printer section 66 that performs a printing operation for the transported sheet. A discharge roller 67 is disposed at the inlet of the discharge tray 57. A pressing roller 68 that comes in pressed contact with the discharge roller 67 is pivotably supported at the side of a free end of the open/close cover 59.

The printer section 66 is composed of a platen 69 arranged in the sheet transporting path 60, a carriage 70 that can reciprocate along this platen 69 in the direction orthogonal to the sheet transporting path 60, the above- mentioned wire dot printer head 1 mounted on the carriage 70, and an ink ribbon cassette 71. It should be noted that the ink ribbon cassette 71 is removably mounted.

The carriage 70 is driven by a motor (not shown) to be reciprocated along the platen 69. The wire dot printer head 1 reciprocates in the main scanning direction with the reciprocating movement of the carriage 70 along the platen 69. Therefore, a head driving mechanism can be realized by the carriage 70 or motor in this embodiment. Further, the wire dot printer 50 has incorporated therein a driving control section 72 for controlling each section in the housing case 51. This driving control section 72 drive-controls each section of the printer section 66, tractor 63 and motor.

In this construction, when a single sheet is used as a sheet, it is fed from the manual tray 54. On the other hand, when plural sheets are continuously used, they are fed from the sheet feed port 55. Either sheet (not shown) is transported by the transporting roller 64, printed by the wire dot printer head 1 and discharged onto the discharge tray 57 by the discharge roller 67.

The printing is performed as follows. Specifically, the coil 29 is selectively excited in the wire dot printer head 1, whereby the armature 4 is attracted by the pole face 28 of the core 27 to be pivoted about the pivot shaft 12, resulting in that the wire 10 is pressed toward the sheet on the platen 69 via the ink ribbon (not shown). When the coil 29 is de-energized, the armature 4 returns under the urging force of the urging member 15 and stops at the stand-by position by the armature stopper 19. Although a sheet is used here as the printing medium, the invention is not limited thereto. For example, a pressure-sensitive color-developing paper can be used in which the color development occurs at the pressurized section. In a case where the pressure-sensitive color-developing paper is used as the printing medium, the color development occurs at the section pressurized by the pressure of the wire 10 provided at the wire dot printer head 1, to thereby execute the printing.

Upon performing the printing operation by the wire dot printer 50, a coil 29 is selectively energized based upon the printing data by the control of the driving control section 72. Then, a magnetic circuit is formed among the core 27 on which the selected coil 29 is mounted, the magnetic circuit forming members 11 of the armature 4 opposed to the core 27, a pair of side yoke sections 33 opposed to the magnetic circuit forming members 11, guide members 32, the outer- and inner-periphery side cylindrical portions 21, 22 of the yoke 6, the bottom face 23 and again the core 27.

The formation of this magnetic circuit generates attraction force that attracts the magnetic circuit forming members 11 to the pole face 28 of the core 27 between the attracted face 14 of the magnetic circuit forming member 11 and the pole face 28 of the core 27. This attraction force allows the armature 4 to pivot about the pivot shaft 12 in the direction in which the attracted face 14 of the magnetic circuit forming member 11 is attracted to the pole face 28 of the core 27. It should be noted that the position where the attracted face 14 of the magnetic circuit forming member 11 of the armature 4 comes in contact with the pole face 28 of the core 27 is defined as the printing position in this embodiment.

As a result of the pivotal movement of the armature 4 to the printing position, the tip of the wire 10 projects to the side of the sheet. Since the ink ribbon is interposed between the wire dot printer head 1 and the sheet at this time, the pressure from the wire 10 is transmitted to the sheet via the ink ribbon and the ink from the ink ribbon is transferred onto the sheet, thereby carrying out the printing.

When the coil 29 is de-energized, the magnetism so far developed becomes extinct, so that the magnetic circuit also vanishes. Consequently, the attractive force for attracting the magnetic circuit forming member 11 to the pole face 28 of the core 27 disappears, so that the armature 4 is urged away from the yoke 6 with an urging force of the urging member 15 and pivots about the pivot shaft 12 toward the stand-by position. The armature 4 pivots toward the stand-by position until its arm 9 comes into contact with the armature stopper 19, whereupon the armature is stopped at the stand-by position.

The printing operation described above is performed at high speed (for example, the printing speed of 2500 times per second). In this case, the armature 4 pivots between the printing position and the stand-by position with 2500 times per second. In order to produce pivotal force for pivoting the armature 4 as described above, the yoke 6 is made of permendur material (Step S1) and the reference surface 6a of the yoke 6 is polished so as to be flattened (Step S2) as shown in FIG. 3, thereby forming the yoke 6 in this embodiment. Accordingly, the reference surface 6a of the yoke 6 is precisely formed to be flat, thereby being capable of restraining the deterioration in assembling precision. Further, the yoke 6 is made of permendur material including plenty of cobalt, thereby being capable of preventing the formation of rust. Additionally, a plating layer that is a cause of magnetic resistance is not formed on the yoke 6, thereby preventing the deterioration in magnetic characteristics and being capable of obtaining magnetic characteristics required for high-speed printing. As a result, high-speed printing is realized. In particular, the permendur material is excellent in magnetic characteristics, thereby being capable of enhancing magnetic characteristics compared to the case of using other materials. Moreover, plating and baking are unnecessary, whereby the manufacturing time is shortened to thereby enhance productivity.

In this embodiment, a wire dot printer head has the yoke 6 formed by the aforesaid manufacturing method of the yoke 6, the coil 29 wound around the core 27 of the yoke 6, and the armature 4 positioned opposite to the core 27, pivotably provided at the yoke 6 and supports the printing wire 10 in a direction generally parallel to its pivotal direction, whereby it restrains the deterioration in assembling precision and prevents the formation of rust and deterioration in magnetic characteristics, thereby being capable of obtaining magnetic characteristics required for high-speed printing. Consequently, high-speed printing is realized.

Moreover, the wire dot printer 50 in this embodiment is provided with the above-mentioned wire dot printer head 1, platen 69 opposite to the wire dot printer head 1, carriage 70 that holds the wire dot printer head 1 and reciprocates along the platen 69, and transporting roller 64 and the pressing roller 65 serving as the printing medium transporting section for transporting a printing medium between the wire dot printer head 1 and the platen 69, wherein the wire dot printer head 1, carriage 70, transporting roller 64 and the pressing roller 65 are drive-controlled to effect printing based upon printing data, whereby it restrains the deterioration in assembling precision and prevents the formation of rust and deterioration in magnetic characteristics, thereby being capable of obtaining magnetic characteristics required for high-speed printing. Consequently, high-speed printing is realized.

Obviously, numerous modifications and variations of the present invention are possible in light of the above teachings. It is therefore to be understood that within the scope of the appended claims, the invention may be practiced otherwise than as specifically described herein.

1. A manufacturing method of a yoke, comprising the steps of:
forming a yoke having a core around which a coil is wound and a reference surface for assembly with permendur material; and
polishing the reference surface so as to be flattened.

2. A yoke comprising:
a core made of permendur material and around which a coil is wound; and
a reference surface for assembly that is polished so as to be flattened.

3. A wire dot printer head comprising:
a yoke that has a core around which a coil is wound and a reference surface for assembly that is polished so as to be flattened, the yoke being made of permendur material;
a coil wound around the core; and
an armature positioned opposite to the core, pivotably provided at the yoke and supports a printing wire in a direction generally parallel to its pivotal direction.

4. A wire dot printer comprising:
a wire dot printer head comprising:
a yoke that has a core around which a coil is wound and a reference surface for assembly that is polished so as to be flattened, the yoke being made of permendur material;
a coil wound around the core;
an armature positioned opposite to the core, pivotably provided at the yoke and supports a printing wire in a direction generally parallel to its pivotal direction;
a platen arranged opposite to the wire dot printer head;
a carriage that holds the wire dot printer head and reciprocates along the platen; and
a printing medium transporting section that transports a printing medium between the wire dot printer head and the platen.
